(19) United States
(12) Patent Application Publication
(10) Pub. No.: US 2026/0210268 A1
(43) Pub. Date: Jul. 23, 2026

(54) SYSTEM AND METHOD FOR FRANGIBLE PLUG ELECTRONIC SHAFT SHEAR DETECTION

(71) Applicant: Pratt & Whitney Canada Corp., Longueuil (CA)

(72) Inventors: Jeffrey Heyerman, Oakville (CA); Nathan Tomes, Hamilton (CA)

(21) Appl. No.: 19/030,779

(22) Filed: Jan. 17, 2025

(51) Int. Cl. F01D 21/04

(52) U.S. Cl. CPC F01D 21/045

(57) ABSTRACT

A system for detecting shaft shear comprises a gas turbine engine including at least one turbine configured to drive a fan using a driveshaft. A plurality of frangible plugs is located downstream of the at least one turbine of the gas turbine engine. The plurality of frangible plugs is configured to provide an indication of shearing of the driveshaft responsive to breakage of at least a portion of the plurality of frangible plugs caused by impact of the at least one turbine with the portion of the plurality of frangible plugs.

### TECHNICAL FIELD

This disclosure relates generally to a system and method for shaft shear detection. More specifically, this disclosure relates to the use of a frangible plug for the electronic detection of shaft shear.

### BACKGROUND

Gas turbine engines generally drive compressors with a shaft using power extracted by a turbine. If the shaft breaks the turbine can rapidly accelerate leading to an over speed condition which if not controlled could lead to a catastrophic failure in the form of a disk of the turbine bursting at high speeds.

One prior solution to this problem involves designing the turbine blades to fail under centrifugal loading well before the disk containing the turbine blades would burst. This requires significant burst margin leading to a heavy design for the turbine. Another prior art solution uses a mechanical feature near the end of the shaft in the downstream direction to trigger a fuel shutoff valve when the turbine moves downstream due to pressure loading when the shaft breaks. This solution is not favored since latent failures in the system are not detectable and the mechanical features are subjected to high temperatures in the exhaust area of the engine. A third solution uses a speed or torque sensor on the gas turbine engine to detect either a change in speed or a change an output torque to identify a failure in the shaft electronically and then use a high speed solenoid valve to shut off the fuel to the gas turbine engine. This prevents further turbine acceleration. This solution, depending on the engine, can require substantial time to detect the failure reliably while avoiding false positives which would lead to in-flight shutdowns. This lag time leads to a higher over speed condition on the turbine and higher weight overall. Depending on the configuration, it can also be difficult to predict the torque signal, making design and validation of the software difficult.

Thus, a solution overcoming the problems involved with these prior art solutions would be of great benefit within gas turbine engine designs with respect to shaft shear detection.

### SUMMARY

This disclosure relates to a system and method for shaft shear detection.

In some examples, a system for detecting shaft shear includes a gas turbine engine including at least one turbine configured to drive a driveshaft, a plurality of frangible plugs located downstream of the at least one turbine of the gas turbine engine, and where the plurality of frangible plugs is configured to provide an indication of shearing of the driveshaft responsive to breakage of at least a portion of the plurality of frangible plugs caused by impact of the at least one turbine with the portion of the plurality of frangible plugs.

Any single one or any combination of the following features may be used with the examples above. The system where the plurality of frangible plugs each further may include a brittle material configured to form a body of a frangible plug, a wire contained within the brittle materials and where the frangible plug is further configured to generate the indication of shearing of the driveshaft responsive to breaking of the wire or the brittle material. The brittle material may include a ceramic material. The at least one turbine further may include a blade shroud surrounding the at least one turbine, the blade shroud configured to define a sawtooth shape to facilitate breakage of the at least the portion of the plurality of frangible plugs responsive to rotation of the blade shroud past the plurality of frangible plugs. The system may include control circuitry configured to detect the indication of shearing of the driveshaft and shut down the gas turbine engine responsive to a detection of the indication of shearing. The system may include a controller configured to receive the indication from the plurality of frangible plugs and generate a control signal to shut down the gas turbine engine. The plurality of frangible plugs is connected in parallel to the controller and a plurality of resistors, each of the resistors connected in series with one of the plurality of frangible plugs. The controller is configured to monitor a load across each of the plurality of frangible plugs and an associated resistor, detect an increase in resistance and generate the control signal responsive to the detected increase in the resistance. The plurality of frangible plugs each further include a thermo-resistive sensor configured to generate the indication responsive to a heat increase caused by rubbing of the turbine with an associated frangible plug.

In other examples, a method for detecting shaft shear includes placing a plurality of frangible plugs downstream of at least one turbine configured to drive a driveshaft within a gas turbine engine, breaking a portion of the plurality of frangible plugs responsive to impact of the at least one turbine with the portion of the plurality of frangible plugs caused by the shaft shear, generating an indication of shearing of the driveshaft responsive to breakage of the at least a portion of the plurality of frangible plugs, and shutting down the gas turbine engine responsive to the indication of shearing.

Any single one or any combination of the following features may be used with the examples above. The method where the step of generating further may include breaking a wire contained within the portion of the plurality of frangible plugs and generating the indication of shearing of the driveshaft responsive to breaking of the wire within the portion of the plurality of frangible plugs. The step of breaking further may include breaking the at least the portion of the plurality of frangible plugs responsive to rotation of a blade shroud configured to define a sawtooth shape past the plurality of frangible plugs. The step of shutting down further may include detecting the indication of shearing of the driveshaft using control circuitry and shutting down the gas turbine engine responsive to the detection of the indication of shearing. The step of shutting down further may include receiving the indication from the plurality of frangible plugs at a controller and generating a control signal by the controller to shut down the gas turbine engine. The method may include connecting the plurality of frangible plugs in parallel to the controller, and connecting each a plurality of resistors in series with one of the plurality of frangible plugs. The method may include monitoring a load across the plurality of frangible plugs and an associated resistor by the controller, detecting an increase in resistance across at least a portion of the plurality of frangible plugs and the associated resistor by the controller, and generating the control signal responsive to the detected increase in the resistance by the controller. The step of generating the indication further may include detecting a heat increase caused by rubbing of the turbine with an associated frangible plug using a thermo-resistive sensor implemented within the plurality of frangible plugs and generating the indication responsive to the detected heat increase.

In still other examples, an apparatus for detecting shaft shear includes a frangible plug configured to detect a shaft shear, a brittle material configured to form a body of the frangible plug, a wire contained within the brittle materials, and where the frangible plug is configured to provide an indication of shearing of a driveshaft responsive to breakage of the wire.

Any single one or any combination of the following features may be used with the examples above. The apparatus where the brittle material may include a ceramic material. The apparatus may include control circuitry configured to detect the indication of shearing of the driveshaft and shut down a gas turbine engine responsive to a detection of the indication of shearing.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example gas turbine engine having frangible plugs inserted after the low-pressure turbine;

FIG. 2 illustrates a plurality of frangible plugs that is connected in series to an engine controller of a gas turbine engine;

FIG. 3 illustrates the interaction between a sawtooth blade shroud and a frangible plug; and

FIG. 4 illustrates a flow diagram of the process for detection of breakage of the frangible plug by a gas turbine engine controller.

### DETAILED DESCRIPTION

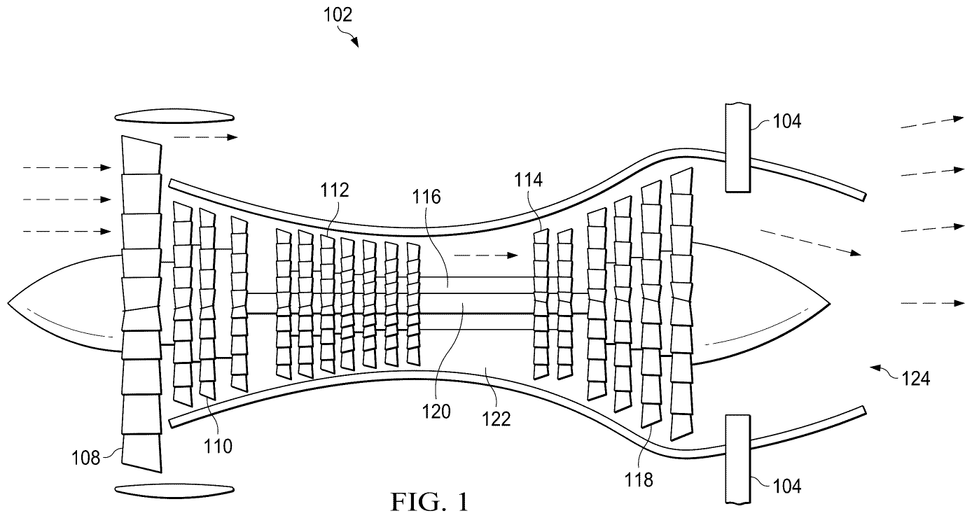

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

FIG. 1 illustrates an example gas turbine engine 102 having frangible plugs 104 inserted downstream of the low-pressure turbine 106. The gas turbine engine 102 comprises a fan 108 connected to a low-pressure compressor 110 and a high-pressure compressor 112. The high-pressure compressor 112 is connected to a high-pressure turbine 114. The high-pressure turbine 114 drives the high-pressure compressor 112 via a high-pressure shaft 116. A low-pressure turbine 118 is connected to the low-pressure compressor 110 via a low-pressure shaft 120. The low-pressure turbine 118 drives the low-pressure compressor 110 and the fan 108 via the rotation of the low-pressure shaft 120. The high-pressure turbine 114 drives the high-pressure compressor 112 by rotation of the high-pressure shaft 116. Rotation of the fan 108 draws air into the gas turbine engine 102. A portion of the air passes through the low-pressure compressor 110 and high-pressure compressor 112 wherein the air is compressed prior to combustion within the combustion chamber 122. The exhaust from the combustion chamber 122 drives the high-pressure turbine 114 and low-pressure turbine 118 and is exhausted out of the nozzle 124.

The low-pressure shaft 120 is located within and rotates separately from the high-pressure shaft 116. Shearing of the low-pressure shaft 120 may cause rapid acceleration of the low-pressure turbine 118 which can cause an over speed condition resulting in catastrophic failure of the low-pressure turbine 118 due to disk bursting. In order to rapidly detect shearing of the low-pressure shaft 120, a plurality of frangible plugs 104 is placed rearward of the low-pressure turbine 118 within the nozzle 124. The frangible plugs 104 comprise high-temperature brittle plugs having embedded electronic fuses which are located just outside of the outer gas path and downstream of the turbine blade shrouds of the low-pressure turbine 118. When a shaft shear decouples the low-pressure turbine 118 from the drive train, the turbine rotor of the low-pressure turbine 118 is separated from its restraint caused by the low-pressure shaft 120 and is pushed downstream toward the nozzle 124 due to gas pressure loading. This causes the blade shrouds of the low-pressure turbine 118 to impact with the frangible plugs 104 causing the frangible plugs to fracture and break embedded wires within the frangible plugs. In one example, the material comprising the frangible plugs 104 is of a material that will break responsive to the impact with the low-pressure turbine 118 responsive to a force in a range of 50-200 lbf. However, it will be appreciated that frangible plugs 104 that break responsive to forces in other ranges may be utilized depending on design considerations for the gas turbine engine. The frangible plugs 104 are designed to have a high enough strength to survive in their normal operating conditions, but intentionally weaker than would be required to remain intact during contact with the low-pressure turbine 118. Detection of the broken wires is possible in a single electronic engine controller (EEC) cycle, and the EEC can shut off the fuel more quickly than in previous solutions. This enables a smaller maximum over speed and lighter design for containment and rotating components.

The frangible plugs 104 are designed to fail in a brittle manner to ensure that the embedded wires are broken. One possible material for the body of the frangible plug 104 is ceramic. However, it will be realized that other brittle materials may also be utilized. The frangible plugs 104 or designed to fail at low forces to ensure that they break well before a blade of the low-pressure turbine 118 would risk fracture. The frangible plugs 104 are located downstream of the low-pressure turbine 118 so that when the frangible plugs fracture, the airflow past the frangible plug pushes broken portions downstream without the risk of false-negatives due to reattachment or foreign object damage (FOD) to rotating components. The frangible plugs 104 would be accessible through inner cowl doors on the exterior of the gas turbine engine 102 and are intended to be easily replaced. It will be understood that the gas turbine engine 102 shown in FIG. 1 is an example for illustrative purposes. This disclosure is not limited to any particular configuration of a gas turbine engine.

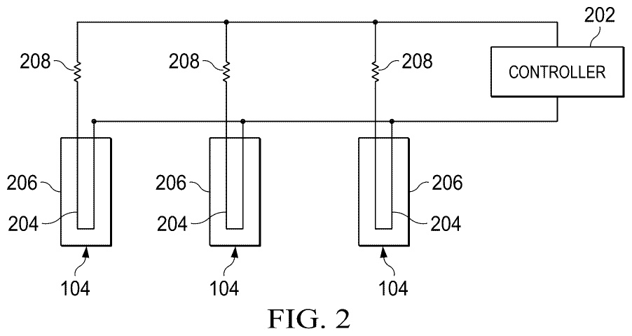

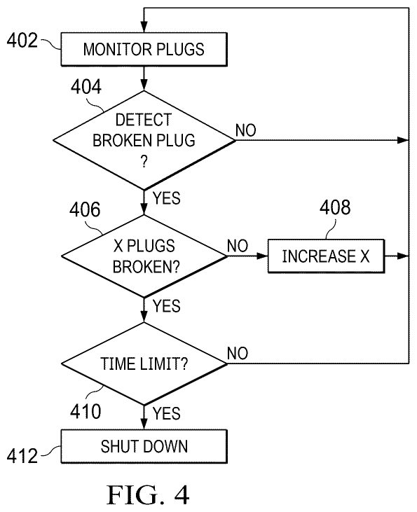

Referring now to FIG. 2, there is illustrated a plurality of frangible plugs 104 that are connected in parallel to an engine controller 202 of a gas turbine engine 102. The engine controller 202 may comprise the EEC, FEC or any other controller of the gas turbine engine 102. While three frangible plugs 104 are illustrated in FIG. 2, it will be appreciated that any number of frangible plugs may be used in order to provide optimal detection of the shearing of the low-pressure shaft 120 (FIG. 1). As illustrated in FIG. 2, each frangible plug 104 has a wire 204 that is encased within the frangible material 206 of the frangible plug 104. Each of the frangible plugs 104 are connected in parallel with the controller 202. The frangible plugs 104 are used as failure sensors by the controller 202 such that when a shear failure is detected, the controller 202 may cut the fuel flow to the gas turbine engine 102 in rapid fashion. There are many possible electrical configurations that would enable detection of the breakage of the wire 204 within the frangible plug 104. In the example illustrated, the frangible plugs 104 are wired in parallel with each other and each frangible plug is connected in series with a resistor 208. Controller 202 utilizes a channel to measure the resistance across each resistor 208. When the resistance jumps, this indicates that the frangible plug 104 has been broken and broken the wire 204 within the frangible plug. The control logic within the controller 202 will be more fully described herein below with respect to FIG. 4. Various other electrical configurations may be used for monitoring breakage of the wire 204 within the frangible plug 104.

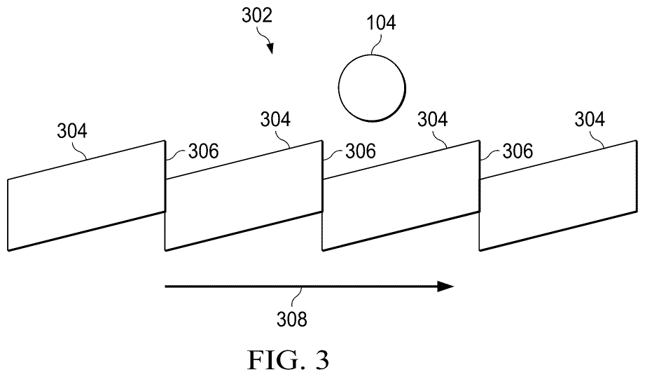

Referring now to FIG. 3, there is illustrated the manner in which the blade shrouds 302 of the low-pressure turbine 118 may be configured to interact with the frangible plug 104 in order to facilitate fracturing of the frangible plug when the blade shrouds 302 moves back into and impacts the frangible plug 104 responsive to shearing of a low-pressure shaft 120. The blade shrouds 302 comprises the outer shroud surrounding the blades (not shown) of the low-pressure turbine 118. The blade shroud 302 may consist of a number of offset portions 304 defining a sawtooth pattern such that the edge 306 of the offset portions 304 may repeatedly strike the frangible plug 104 responsive to rotation of the blade shroud 302 in the direction indicated by the arrow 308. Repeated striking of the frangible plug 104 by the sawtooth edge 306 of the blade shroud 302 will ensure breaking of the brittle material associated with the frangible plug 104. The sawtooth pattern defined by the portions 304 of the blade shroud 302 provide tangential impact on the frangible plug 104 in order to ensure that the frangible plugs will fracture even at low power.

Referring now to FIG. 4, there is illustrated a flow diagram describing one manner of operation of the controller 202 (FIG. 2). The controller 202 monitors at step 402 each of the frangible plugs 104 that are connected to the gas turbine engine. Inquiry step 404 determines if a broken frangible plug 104 is detected and if not control passes back to step 402 to continue to monitor the plugs. If inquiry step 404 detects a broken frangible plug 104, inquiry step 406 determines if a predetermined number (X) of plugs have been broken. If not, control passes to step 408 wherein the number of broken frangible plug 104 is increased by one and control passes back to step 402. If a predetermined number of frangible plugs 104 is determined to have broken at step 406, inquiry step 410 determines if the number of broken frangible plugs 104 has occurred within a particular number of milliseconds. However, any time period may be used. If not, control passes back to step 402 to continue monitoring the frangible plugs 104. If inquiry step 410 determines that the predetermined number of frangible plugs 104 have broken within the required time limit, the shutdown procedure for the gas turbine engine is initiated at step 412. The shutdown procedure may in various embodiments comprise shutting down the fuel supply to the gas turbine engine or other manners of gas turbine engine shutdown. False positives with respect to breakage of the frangible plugs 104 are avoided by only triggering the indication of shaft share by the controller 202 if the predetermined number of plugs are broken within a predetermined time period. Additionally, if a certain number of plugs have not failed in the predetermined time period but at least one has, a new baseline is established and a flag can be set to perform engine maintenance.

In addition to locating the frangible plugs 104 downstream of the low-pressure turbine 118, the frangible plugs 104 may be located at different stages having an increased risk of FOD. The frangible plugs 104 could be located on the inner gas path by using an increased length of wiring in harsh environments such as through the exhaust case or MTF struts. Frangible plug 104 replacement would also become more difficult depending upon access and gas path dimensions.

The frangible plugs 104 could be used without a resistor and/or on separate EEC channels to enable breakage detection. The frangible plugs 104 could be located aft of the end of the shaft such as at the mechanical fuel shutoff plunger location. This would require wiring to pass through harsh environments but would move the frangible plugs 104 out the gas path entirely. Access to these frangible plugs when only be possible with removal of the tail cone.

The frangible plugs 104 could be configured as a thermo-resistive sensor such that they could detect a sudden rise in temperature due to rubbing of the shaft occuring in a low-power condition when backward movement of the turbine was not energetic enough to fracture the frangible plugs 104. Thus, initiation of the fuel cutoff control signals would be caused by detected heat increases caused by rubbing of the turbine 118 against the frangible plug 104 rather than by its breakage.

The frangible plugs 104 may be combined with other detection methods for shaft shear detection to provide a manner to better confirm shaft shear. In some cases, a quick detection may be used to drop fuel flow to minimum levels and then shut off is initiated. Combining detection methods could be implemented in a few ways. In a first example, The EEC detects 3 of 8 plug fractures and sends a signal to the fuel shutoff valve to reduce flow to minimum levels required to sustain a flame. If this is a true shaft shear the acceleration of the turbine is reduced, otherwise the whole spool will decelerate. Two possible situations follow. Approximately 40 ms after the first detection, the EEC detects a rapid reduction in compressor speed that does not match what would occur with only a reduction in fuel flow. This serves as confirmation of a shaft shear event has occurred, so the EEC sends the signal to the fuel shutoff valve to fully close. Alternatively, 15 s after the first detection, all systems and speeds appear to be stable, behaving normally and the remaining 5 plugs have not fractured. The EEC identifies the previous detection as a possible false positive and sends commands to the fuel valve and other systems to accelerate by 5%. The engine responds as it should, and the event is confirmed as a false positive.

In a second example, the EEC detects 3 of 8 plug fractures and flags a possible shaft shear event. Two possible situations may follow. At 10 ms after the first detection, a torque drop is detected by the EEC. The EEC interprets this as confirmation of a shaft shear event and sends a signal to the fuel shutoff valve to shut off all fuel flow as quickly as possible. Alternatively, at 100 ms after the event the torque level and shaft speed remain stable, and the EEC removes the flag for a possible shaft shear event without taking further action.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A system for detecting shaft shear, comprising:
a gas turbine engine including at least one turbine configured to drive a driveshaft;
a plurality of frangible plugs located downstream of the at least one turbine of the gas turbine engine, wherein the plurality of frangible plugs each further comprises:
a brittle material configured to form a body of a frangible plug, wherein the brittle material is configured to break responsive to impact of the at least one turbine with the body of the frangible plug;
a wire embedded within the frangible plug;
wherein breakage of the brittle material is further configured to break the wire embedded within the frangible plug and generate an indication of shearing of the driveshaft responsive to breaking of the wire; and
wherein the plurality of frangible plugs each further include a thermo-resistive sensor configured to generate the indication responsive to a heat increase caused by rubbing of the turbine with an associated frangible plug.

2. (canceled)

3. The system of claim 1, wherein the brittle material comprises a ceramic material.

4. The system of claim 1, wherein the at least one turbine further comprises:
a blade shroud surrounding the at least one turbine, the blade shroud configured to define a sawtooth shape to facilitate breakage of the frangible plug responsive to rotation of the blade shroud past the plurality of frangible plugs.

5. The system of claim 1 further comprising control circuitry configured to detect the indication of shearing of the driveshaft and shut down the gas turbine engine responsive to a detection of the indication of shearing.

6. The system of claim 1 further comprising a controller configured to receive the indication from the frangible plug and generate a control signal to shut down the gas turbine engine.

7. The system of claim 6 further comprising:
wherein the plurality of frangible plugs is connected in parallel to the controller; and
a plurality of resistors, each of the resistors connected in series with one of the plurality of frangible plugs.

8. The system of claim 7, wherein the controller is configured to monitor a load across each of the plurality of frangible plugs and an associated resistor, detect an increase in resistance and generate the control signal responsive to the detected increase in the resistance.

9. (canceled)

10. A method for detecting shaft shear, comprising:
placing a plurality of frangible plugs downstream of at least one turbine configured to drive a driveshaft within a gas turbine engine;
breaking a portion of a brittle material forming a body of the plurality of frangible plugs responsive to impact of the at least one turbine with the portion of the plurality of frangible plugs caused by the shaft shear;
breaking a wire embedded within the brittle material responsive to breakage of the brittle material;
generating an indication of shearing of the driveshaft responsive to breakage of the wire embedded within the brittle material;
wherein the step of generating the indication further comprises:
detecting a heat increase caused by rubbing of the turbine with an associated frangible plug using a thermo-resistive sensor implemented within the plurality of frangible plugs; and
generating the indication responsive to the detected heat increase; and
shutting down the gas turbine engine responsive to the indication of shearing.

11. (canceled)

12. The method of claim 10, wherein the step of breaking further comprises breaking the at least the portion of the plurality of frangible plugs responsive to rotation of a blade shroud configured to define a sawtooth shape past the plurality of frangible plugs.

13. The method of claim 10, wherein the step of shutting down further comprises:
detecting the indication of shearing of the driveshaft using control circuitry; and
shutting down the gas turbine engine responsive to the detection of the indication of shearing.

14. The method of claim 10, wherein the step of shutting down further comprises:
receiving the indication from the plurality of frangible plugs at a controller; and
generating a control signal by the controller to shut down the gas turbine engine.

15. The method of claim 14 further comprising:
connecting the plurality of frangible plugs in parallel to the controller; and
connecting each a plurality of resistors in series with one of the plurality of frangible plugs.

16. The method of claim 15 further comprising:
monitoring a load across the plurality of frangible plugs and an associated resistor by the controller;
detecting an increase in resistance across at least a portion of the plurality of frangible plugs and the associated resistor by the controller; and
generating the control signal responsive to the detected increase in the resistance by the controller.

17-20. (canceled)

21. A system for detecting shaft shear, comprising:
a gas turbine engine including at least one turbine configured to drive a driveshaft;
a plurality of frangible plugs located downstream of the at least one turbine of the gas turbine engine;
wherein the plurality of frangible plugs each further include a thermo-resistive sensor configured to generate the indication responsive to a heat increase caused by rubbing of the turbine with an associated frangible plug; and
wherein the plurality of frangible plugs is configured to provide an indication of shearing of the driveshaft responsive to breakage of at least a portion of the plurality of frangible plugs caused by impact of the at least one turbine with the portion of the plurality of frangible plugs.

22. The system of claim 21, wherein the at least one turbine further comprises:
a blade shroud surrounding the at least one turbine, the blade shroud configured to define a sawtooth shape to facilitate breakage of the frangible plug responsive to rotation of the blade shroud past the plurality of frangible plugs.

23. The system of claim 21 further comprising control circuitry configured to detect the indication of shearing of the driveshaft and shut down the gas turbine engine responsive to a detection of the indication of shearing.

24. The system of claim 23 further comprising:
wherein the plurality of frangible plugs is connected in parallel to the control circuitry; and
a plurality of resistors, each of the resistors connected in series with one of the plurality of frangible plugs.

25. The system of claim 24, wherein the control circuitry is configured to monitor a load across each of the plurality of frangible plugs and an associated resistor, detect an increase in resistance and generate the control signal responsive to the detected increase in the resistance.
